(19) United States
(12) Patent Application Publication
(10) Pub. No.: US 2014/0065351 A1
(43) Pub. Date: Mar. 6, 2014

(54) FORMING CELLULAR MATERIAL BY MELT-STRETCHING MELT-STRETCHABLE MATERIAL

(71) Applicant: Fly Technologies Inc., Mississauga (CA)

(72) Inventors: Robert Brent CORDNER, Toronto (CA); Glenn David HIBBARD, Toronto (CA)

(73) Assignee: Fly Technologies Inc., Mississauga (CA)

(21) Appl. No.: 14/074,784

(22) Filed: Nov. 8, 2013

Related U.S. Application Data
(63) Continuation of application No. PCT/CA2011/000646, filed on May 31, 2011.

(51) Int. Cl. B29C 44/56; B65D 81/03

(52) U.S. Cl. CPC B29C 44/5627; B65D 81/03
USPC 428/116; 264/45.4; 428/318.8; 428/316.6

(57) ABSTRACT

A material with a cellular structure is formed from melt-stretched granules. Granules compressed between stretching surfaces are melted to form viscous molten layers attaching ends of the granules to the surfaces. Melted central portions of the granules are stretched by moving the surfaces away from one another. A cellular structure is thus formed between the molten layers, both of which are solidified to form a solid material. A cellular material may also be formed by melting a melt-stretchable material to form a sheet of viscous molten mass formed of opposite surface layers connected by a central portion, stretching the central portion by pulling the surface layers away from one another to generate air cells randomly distributed throughout the central portion, and solidifying the cellular core and the skins formed from the central portion and the surface layers.

### CROSS-REFERENCE TO RELATED APPLICATIONS

The present application is a continuation of PCT patent application serial no. PCT/CA2011/000646, filed May 31, 2011, which designates the United States, and the contents of which are hereby incorporated by reference.

### FIELD OF THE INVENTION

The present invention relates to cellular materials and methods of forming such materials.

### BACKGROUND OF THE INVENTION

Cellular materials have varied applications and are useful in many industries including aerospace, automotive, packaging, construction, and other industries. A common type of cellular materials is foamed plastics. It is common to sandwich a thick cellular sheet material between two thin sheet panels, known as face sheets. Typically, the face sheets are bonded to the cellular sheet material, such as by an adhesive, and are of a material that is different from the cellular sheet material.

A common technique for producing cellular materials is foaming where gas cells are created inside a plastic material before the plastic material is solidified. Typical known foaming techniques involve the use of a blowing agent which creates gas cells inside the material during the material manufacture process; and the foamed material is then subjected to a forming process such as a thermoforming process to obtain the desired product shape.

There are many known thermoforming techniques. Typically, a plastic sheet is heated to a pliable forming temperature and is formed to a specific shape in, or with, a mold, such that the surface shape of the plastic sheet conforms to the surface shape of a part of the mold. For example, typical thermoforming techniques include vacuum forming, injection molding, compression molding, extrusion, stretch forming, and other techniques. Stretch forming is a process in which a heated thermoplastic sheet is stretched along the sheet surface over a mold and subsequently cooled. Typically, the sheet is heated to a high-enough temperature that it can be stretched into or onto a mold, and then cooled to a finished shape.

A Bubble Wrap™ material is typically formed by laminating a first plastic sheet over a second plastic sheet which is tightly wrapped around a forming surface having cavities with vacuum being applied to suck the second sheet to conform to the cavity wall so that air bubbles are trapped between the laminated sheets.

### SUMMARY OF THE INVENTION

It is desirable to provide an alternative process for producing and shaping cellular materials.

It is also desirable to provide a convenient, simple process for producing and shaping cellular materials, and for forming cellular materials with a cellular core and dense skins that are made of the same material.

It is further desirable to provide a cellular material that has a combination of desired properties, such as relatively light weight and high mechanical strength.

It is further desirable to provide a cellular plastic material that is relatively easy to reform, repair, or recycle.

It has been realized by the present inventors that cellular materials may be produced by melt-stretching a melt-stretchable material having relative high melt strength, without the use of a blowing agent or laminating different sheets of materials.

Accordingly, in a first aspect of the present invention, there is provided a method of forming a cellular material, comprising melting granules compressed between a first surface and a second surface, to form a first viscous molten layer attaching first ends of the granules to the first surface and a second viscous molten layer attaching second ends of the granules to the second surface; stretching melted central portions of the granules between the first and second ends by moving the first and second surfaces away from one another, to form a cellular structure between the molten layers; and solidifying the molten layers and cellular structure to form a solid material comprising a cellular core formed from the cellular structure and skins formed from the molten layers.

In exemplary embodiments, the first and second surfaces may be substantially parallel. The first and second surfaces may be substantially flat. The granules may be melted by heating, such as heating the granules to a temperature above the melting temperature of the granules. The molten layers may be solidified by cooling. The granules may be formed of a thermoplastic polymer. The thermoplastic polymer may comprise polypropylene or polyethylene, or another suitable material. The surfaces may be subsequently separated from the solid material.

In another aspect, there is provided a material comprising a cellular structure formed from melt-stretched granules.

In exemplary embodiments, the material may comprise skins covering the cellular structure. The cellular structure may comprise webs connecting the skins. The skins may have a porosity of less than 2%. The cellular structure may have a porosity of about 10% or higher. The granules may be formed of a thermoplastic polymer. The polymer may comprise polypropylene or polyethylene. The cellular structure may comprise randomly arranged honeycomb cells.

In a further aspect, there is provided a method of forming a cellular material, comprising melting a melt-stretchable material to form a sheet of viscous molten mass formed of opposite surface layers connected by a central portion; stretching the central portion by pulling the surface layers away from one another to generate air cells randomly distributed throughout the central portion, without severing the central portion from the surface layers, thus forming a cellular core from the stretched central portion and skins from the surface layers; and solidifying the cellular core and the skins to form a cellular board material.

In exemplary embodiments, the surface layers may be substantially parallel. The surface layers and the skins may be substantially flat. One surface layer may adhere to a first pulling member and another surface layer may adhere to a second pulling member, and the surface layers may be pulled away from one another by moving the first and second pulling members away from one another. The sheet of molten mass may be continuously fed through a pair of nip rollers. The nip rollers may compress a portion of the sheet between the nip rollers when the portion of the sheet is fed through the nip rollers; adhere to the portion when the portion is compressed between the nip rollers; and pull the surface layers of the portion away from one another as the portion leaves the nip rollers, before the portion is solidified and separated from the nip rollers.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1A is a schematic side elevation view of a setup for forming a cellular material by melt-stretching thermoplastic granules, exemplary of an embodiment of the present invention;

FIG. 1B is a schematic top plan view of the setup of FIG. 1 A;

FIG. 2 is a schematic side elevation view of the setup of FIG. 1A, shown the effect of applying heat to melt the granules;

FIG. 3 is a schematic side elevation view of the setup of FIG. 1A, with the top platen raised to stretch the melted granules;

FIG. 4 is a schematic side elevation view of a cellular material formed in the process shown in FIGS. 1A to 3, exemplary of an embodiment of the present invention;

FIG. 5 is a top view image of a portion of a sample cellular material;

FIG. 6 is a perspective view image of a sample cellular material;

FIG. 7 is bar graph of distribution of web thickness in a sample cellular material;

FIG. 8 is a bar graph of distribution of web length in a sample cellular material;

FIGS. 9, 10, and 11 are scanning electron microscopy (SEM) images of the internal cell structures of different sample cellular materials;

FIG. 12 is a line graph showing the strength of sample cellular materials;

FIGS. 13, 14, 15, and 16 are SEM images of the internal cell structures at different strain loadings;

FIG. 17 is a data graph showing the compression strength of different sample cellular materials;

FIG. 18 is a data graph showing the elastic modulus of different sample cellular materials;

FIG. 19 is a data graph showing the load-deflection of different sample cellular materials;

FIG. 20 is a data graph showing the flexural strength of a sample material;

FIG. 21 is a data graph showing the flexural stiffness of a sample material;

FIG. 22 is a data map showing the failure mechanism in samples of different relative densities;

FIGS. 23, 24, and 25 are data graphs showing the load deflection in different test samples;

FIG. 26 is a schematic side elevation view of a nip roller setup for forming a cellular material by melt-stretching; and

FIG. 27 is a schematic side elevation view of another nip roller setup for forming a cellular material by melt-stretching.

### DETAILED DESCRIPTION

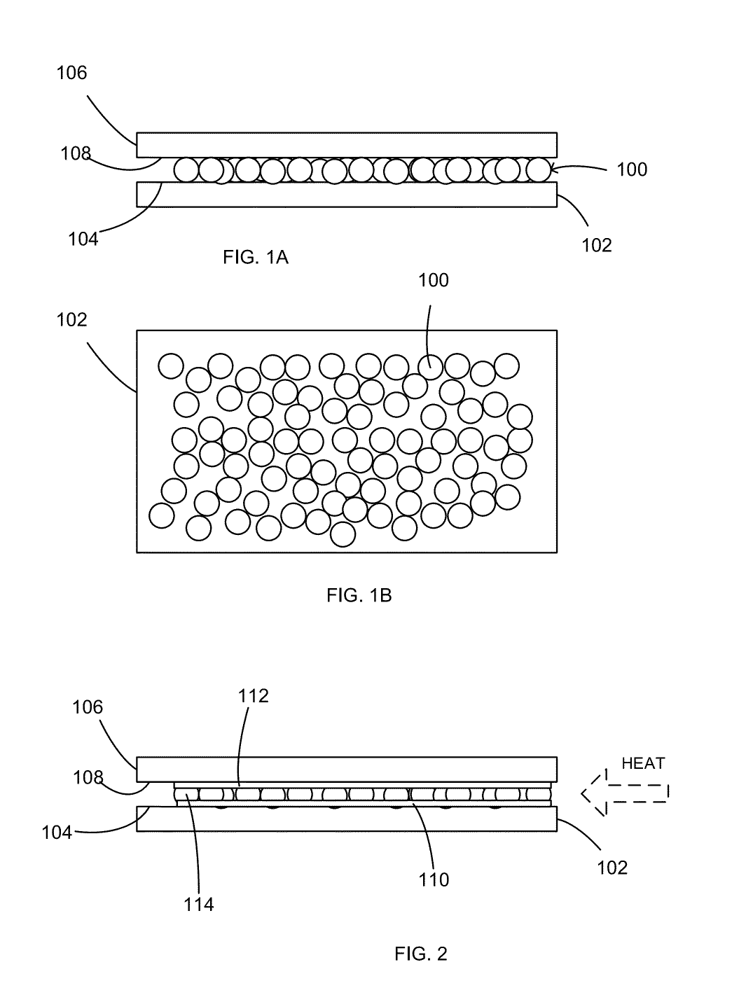

An exemplary embodiment of the present invention relates to a method of forming a cellular material, as illustrated in FIGS. 1A, 1B, 2, 3, and 4.

As illustrated in FIGS. 1A and 1B, a layer of melt-stretchable granules 100 are compressed between a lower platen 102 having an upper surface 104 and an upper platen 106 having a lower surface 108. Surfaces 104 and 106 are generally flat and substantially parallel, and may be referred to as the stretching surfaces herein.

Granules 100 may have any suitable shape or size. While generally spherical granules are depicted in the drawings, other shapes may also be suitable in different embodiments. For instance, cubic or randomly shaped granules may also be used. The sizes of the granules may be selected based on the desired sizes and properties of the product, or the requirements of the particular application. In selected embodiments, the sizes of the granules may vary in the range of about 2 to about 8 mm. For example, for a given product density, if a thicker board product is desired, larger granules may be used; and if a thinner board is desired, smaller granules may be used. For a given board thickness, if a higher porosity in the product is desired, smaller granules may be used. The shapes or sizes of granules 100 may be substantially uniform. However, in some embodiments, there may be some variation in shape and size of granules 100. The variation may be random or controlled as will be further discussed below. In some embodiments, standard plastic pellets provided by commercial suppliers may be conveniently used. The sizes of the granules may be selected to achieve a desired area density (the weight of the granule material per unit area on the surface of the platen), which may in turn be selected to control the pore structure and the thickness of the resulting product.

Granules 100 are made of a melt-stretchable material, which may include a thermoplastic polymer. A melt-stretchable material refers to a material that has relatively high melt strength so that the melted material is capable of undergoing continuous and substantial deformation under a stretching force without rupture. Suitable melt-stretchable polymers include polypropylene (PP) and polyethylene (PE). As will become apparent below, the melt-stretchable material should have a melting temperature well above room temperature, and a relatively high viscosity in a melt state, low melt flow index (MFI), or high melt strength. As can be appreciated by those skilled in the art, melt flow index, melt flow rate and melt index are often used interchangeably to refer to the same property.

For instance, a polypropylene (PP) with a melt strength of about 0.31 N may be suitable. Melt strength may be measured according to ISO 16790 (see ISO 16790:2005 Plastics—Determination of drawing characteristics of thermoplastics in the molten state. International Organization for Standardization. 2005.

The melt-stretchable material should also have the desired properties for the particular application in which the resulting product is to be used, as will be understood by those skilled in the art. Optionally, different additives may be incorporated into granules 100, as will be further discussed below.

Platens 102 and 106 may be made of any suitable material. For example, a metal such as aluminum may be used. Depending on what granule material is used, surfaces 104, 108 of platens 102 and 106 are selected such that a molten layer of the granule material is sufficiently adhesive to surfaces 104, 108, the reasons for which will become apparent below. It may be convenient if the melt-stretchable material in a solid state can be easily separated from surfaces 102 and 104. If necessary or desirable, a surface treatment may be applied to surfaces 104, 108 to provide the desired adhesiveness and compatibility with the granule material.

Granules 100 may be closely packed or loosely packed between platens 102 and 106, depending on the desired product. For example, loosely packed granules may provide a less dense final product. However, granules 100 should be sufficiently close to each other to allow the process described next to take place. In particular, granules 100 should be sufficiently close to one another so that an integral final product can be obtained.

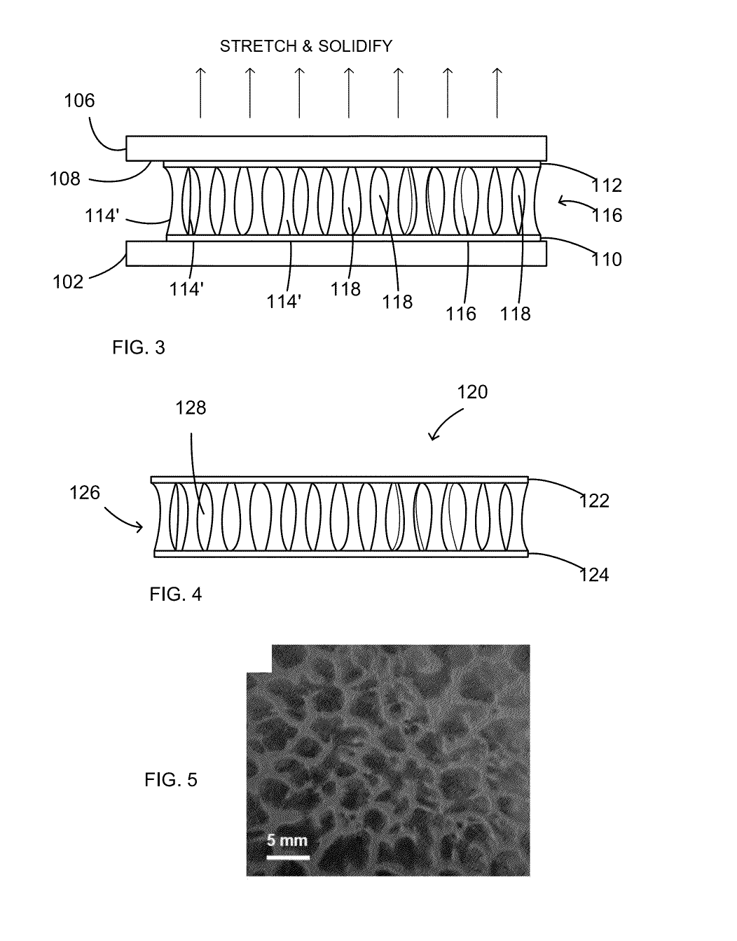

As shown in FIG. 2, heat is applied to granules 100 to sufficiently soften and melt the thermoplastic material, such that a viscous molten layer 110 is formed on surface 104 and a viscous molten layer 112 is formed on surface 108. Heat may be applied through platens 102 and 106. A hot gas or air may also be fed to granules 100 through the space between surfaces 104, 108 to heat the granules. The applied heat and the temperature in the granules should be controlled so that the central portions 114 of granules 100 are also softened and melted but do not rupture (break apart) or loose their stretchability. In some embodiments, some air space may still exist between adjacent melted granules 100 and limited contact and merging between adjacent granules 100 may occur. In other embodiments, the melted granules may be compressed to form a continuous sheet of molten mass without substantial air gaps. As molten layers 110 and 112 are adhesive to surfaces 104 and 108, molten layer 110 attaches lower ends of melted granules 100 to surface 104 and molten layer 112 attaches upper ends of melted granules 100 to surface 108. To form or control the thickness of molten layers 110, 112, the distance between surfaces 104 and 108 may be adjusted before, during, or after applying heat and melting granules 100.

In some embodiments, granules 100 may be first melted and then compressed. In other embodiments, granules 100 may be first compressed between stretching surfaces 104, 108 and then melted while continuing to apply the compression pressure. The compression pressure applied to granules 100 may be adjusted as they soften.

As shown in FIG. 3, platen 106 is next lifted up to stretch the melt central portions 114 to form a cellular structure 116, as the stretched central portions 114′ are thinned and a larger air space 118 is created between the stretched and thinned central portions 114′. When platen 106 is raised, platen 102 may be fixed in place, or simultaneously lowered. Platens 102 and 106 may be moved in any suitable manner to move stretching surfaces 104 and 108 away from each other in order to stretch melted granules 100. The final distance between stretching surfaces 104 and 108 may be selected based on the desired thickness of the product board.

As now can be appreciated, it may be convenient if the granule material and the platen material are selected so that the molten granule material will be tacky and sufficiently adhesive to the stretching surfaces, without the need to apply a surface treatment to the stretching surfaces. For example, molten PP is found to be sufficiently adhesive to aluminum surfaces.

As now can be understood, the melted granule material should have sufficient viscosity or melt strength to allow the central portions 114 be stretched to the desired extent without splitting.

Once stretching surfaces 104 and 108 are moved away to the selected distance, the distance may be maintained and the stretched material may be cooled to solidify it. The stretched material may be air cooled. For mass production, the cooling process may be accelerated to improve production cycle time.

As shown in FIG. 4, the solidified material forms a board 120 having skins 122, 124 connected by a cellular core 126. Skins 122, 124 are formed (solidified) from layers 110 and 112, and cellular core 126 is formed (solidified) from cellular structure 116. The cellular core 126 defines cells 128 formed from air space 118. Skins 122, 124 are denser and less porous than cellular core 126. For example, skins 122, 124 may have a porosity of about 2% or less, and cellular core 126 may have a porosity of about 10% or higher. In selected embodiments, the core porosity may be about 20% or higher. In some embodiments, the core porosity may be about 50% or higher. In some embodiments, the core porosity may be about 85% to about 95%. Depending on the granule material used, skins 122, 124 may be non-porous. Conveniently, the cooled and solidified thermoplastic material may be easily detached from surfaces 104 and 108. In some embodiments, skins 122, 124 may spontaneously detach from stretching surfaces 104 and 108.

As can be understood, the board thickness may be adjusted by adjusting the distance between the stretching surfaces 104 and 108 when the material is cooled to solidify (referred to as the “cooling distance”); and the porosity or relative density in the cellular core 126 may be controlled by adjusting the initial packing of the granules and the cooling distance between the stretching surfaces 104 and 108.

Granules 100 may be melt-stretched so that the stretched center portion 114′ of an individual granule 100 forms a thin web connecting skins 122, 124 and cellular core 126 has a web structure. In some embodiments, the web may have a central thickness of less than 1 mm. When granules 100 are initially randomly distributed between the stretching surfaces, the web structure may be a stochastic (randomly arranged) honeycomb structure.

Board 120 may be further processed. For example, an external face sheet (not shown) may be attached or bonded to one or each of the sides of board 120. The face sheet may be made of any material, such as polymers, metals, or the like. A thermoplastic polymeric face sheet may be attached to board 120 without using an external adhesive. Face sheets or other treatment of the board may be provided to reinforce or protect board 120, modify the appearance of the final product, or to provide any other functionality as will be understood by those skilled in the art. In selected embodiments, the granules may be placed between pre-formed face sheets during the melt-stretching process to form an integral board. In selected embodiments, separate face-sheets may be attached to the board after the melt-stretching process.

The edges or open sides of board 120 may be further shaped or sealed by heating or applying an external material such as a sealing sheet or film.

Board 120 may be re-shaped such as cut or reformed to provide a desired product shape or size. For example, boards of standard sizes may be formed and supplied to end users and be cut into the desired sizes by the end users.

Conveniently, board 120 can be made to have a high porosity (and consequently light weight) and strong mechanical strength. In some embodiments, the porosity in the cellular core may be in the range of about 10% to about 95%. Porosity may be calculated as the ratio of total pore volume and total volume, and may be indicated by relative density, which may be calculated from the ratio of the density of board 120 to the density of the granule material. The density of a material may be measured in any suitable manner known to those skilled in the art. For example, the density may be determined by measuring the weight and volume and dividing the measured weight by the measured volume of the material in question. The relative density of the cellular material may be in the range of about 10% to about 95% in selected embodiments.

In some embodiments of the exemplary method, it is not necessary to use any blowing agents, adhesives, or other additives. It is also not necessary to provide separate foaming and forming processes. The exemplary method described herein can thus be convenient and simple to perform.

The upper and lower end portions and the central portions of granules 100 may be made of the same or different materials. When the end portions and central portions of granules 100 are made of the same material, the skins 122, 124 and the cellular core 126 of board 120 can be conveniently made of the same material. Depending on the melt-stretchable material used, the board material may be relatively easy to recycle such as when it contains only one polymer.

It is also possible in different embodiments to provide granules in which the material in the end portions in contact with surfaces 104, 108 and the material in the central portions are different, so that the skins and the cellular core are of different materials.

Board 120 may be convenient to reform, such as by applying heat or using a suitable plastic reforming technique known to those skilled in the art. For example, a cellular board described herein may be stamped with a hot die to obtain parts with desired shapes. Conveniently, a part stamped from the board or a reformed board may substantially retain the porosity and mechanical strength of the initial board. In at least some embodiments, when board 120 is mechanically damaged, it can be conveniently repaired by re-facing, re-forming, or fusing with a new part. For example, it is possible to re-stretch a damaged portion of the board by heating the damaged portion, attaching the skins of on the damaged portion to two stretching surfaces, and moving the stretching surfaces away from one another to stretch the core of the damaged portion. The edges of board 120 may also be sealed by, for example, pinching the edge with a hot die. When all the edges are sealed, the sealed board may be able to float in water. Either the board (sheet) or a die-stamped part from the board can be fully sealed to allow floatation. Sealed boards and parts can also prevent air, moisture and dirt from entering into the cellular structure inside the boards or parts. Multiple boards may be fused together to form an integrated product, such as during a die-stamping process. For example, multiple boards may be used to fill a die cavity. Fusing of the boards may occur at the edges of the boards or at other locations where the boards are sufficiently compressed by the die.

As now can be appreciated, some modifications to the exemplary method described above may be made. In general, the methods described herein may be modified to provide other cellular materials containing a cellular structure formed from melt-stretched granules. For example, different granule materials may be used, and different stretching apparatus or process may be used. Further, cellular materials of different shapes may be formed. Depending on the materials used, melting of granules may be effected by a method other than applying heat, and solidification may be effected by a method other than cooling.

In some embodiments, the granules may be made of other materials that are suitable for the melt-stretching method, as long as the materials have the following characteristics. First, the material can be melted to form a viscous melt adhesive to the stretching surface (such as surfaces 104, 108) and have sufficient melt strength or viscosity in the melt state to allow stretching of the central portion to the desired length without splitting or melting away. In this regard, an additive may be added to the material to improve its viscosity, stickiness, or other properties. Pre-melted granules may be used in some embodiments, such as by applying individual droplets of the melt material at different spots on the lower stretching surface, although such a process may be less convenient as compared to dispersing solid granules on the stretching surface. Secondly, the granule material can be solidified and remains in the solid state at the normal use conditions. In this regard, thermoplastic materials are convenient to use. However, other materials may also be useful. Granules of resins may be used and may be solidified by curing. Melt-stretchable materials that are tacky when melted but non-adhesive when solidified may be convenient to use, as surface molten layers may be conveniently pulled away from each other by the stretching surfaces due to adhesion between the molten layers and the stretching surfaces, while the solidified skins can be conveniently separated from the stretching surfaces once cooled.

As noted above, in some embodiments, the granules may be melted and compressed to form a continuous sheet of molten mass before the surface layers are pulled away from one another.

As can be appreciated, in some embodiments, it is not necessary to form the sheet of viscous molten mass from granules. For example, a sheet of viscous molten mass formed of opposing surface layers connected by a central portion may be formed by melting another form of the melt-stretchable material, such as a flat sheet, and compressing the molten mass between two flat stretching surfaces, such as surfaces 104, 108. The melt-stretchable material may also be provided in the form of a regrind.

To assist the generation and distribution of air cells in the central portion, especially when air gaps are initially eliminated by compression, the distance between the stretching surfaces may be repeatedly increased and decreased before cooling, so as to repeatedly pull the surface layers apart and push them towards each other. This can assist aeration in the inner regions of the central portion of the molten mass.

To assist the formation of the skin layers with a generally uniform thickness, the stretching surfaces may be vibrated transversely (i.e. in the direction parallel to the stretching surface).

The stretching surfaces may be provided in different forms. For example, platens 102 and 106 may be replaced with other suitable pulling members or devices. The stretching surfaces may be curved so that the product material has a desired surface shape. The two opposing stretching surfaces may be inclined at a limited angle so that the product material has a varying thickness. Two or more separate stretching devices may be provided on one side (e.g. the upper side) so that different portions of surface 108 may be raised to different heights to produce a board with stepped-thickness.

When the melted granules are stretched substantially vertically, it is only necessary to bond the upper molten layer (e.g. layer 112) to the upper stretching surface (e.g. surface 108), as in some embodiments, the weight of the lower molten layer (e.g. layer 110) may be sufficient to maintain attachment of the central portions (e.g. central portions 114, 114′) to the lower stretching surface during stretching. In such a case, it may not be necessary to make the lower molten layer adhesive to the lower stretching surface.

While it is convenient that the melted granules are stretched vertically, in different embodiments it may be possible to stretch the melted granules in other directions if the melted granules are of sufficient melt strength or viscosity and sufficiently adhesive to the stretching surfaces to prevent undesired lumping, dripping, or bending of the central portions.

The shapes and sizes of granules 100 may be controlled in some embodiments. Dispersion of granules on the stretching surface may also be controlled. In some embodiments, the granules may be substantially uniformly distributed, or the positions of the granules may be precisely controlled to provide a more controlled cellular structure in the product. The stretching surface may be shaped to facilitate dispersion and precise positioning of the granules.

Cellular materials with different thickness and size may be produced according to exemplary embodiments described herein. Instead of board materials, other cellular materials, such as sheet materials, block materials, or the like, may also be produced by melt-stretching granules.

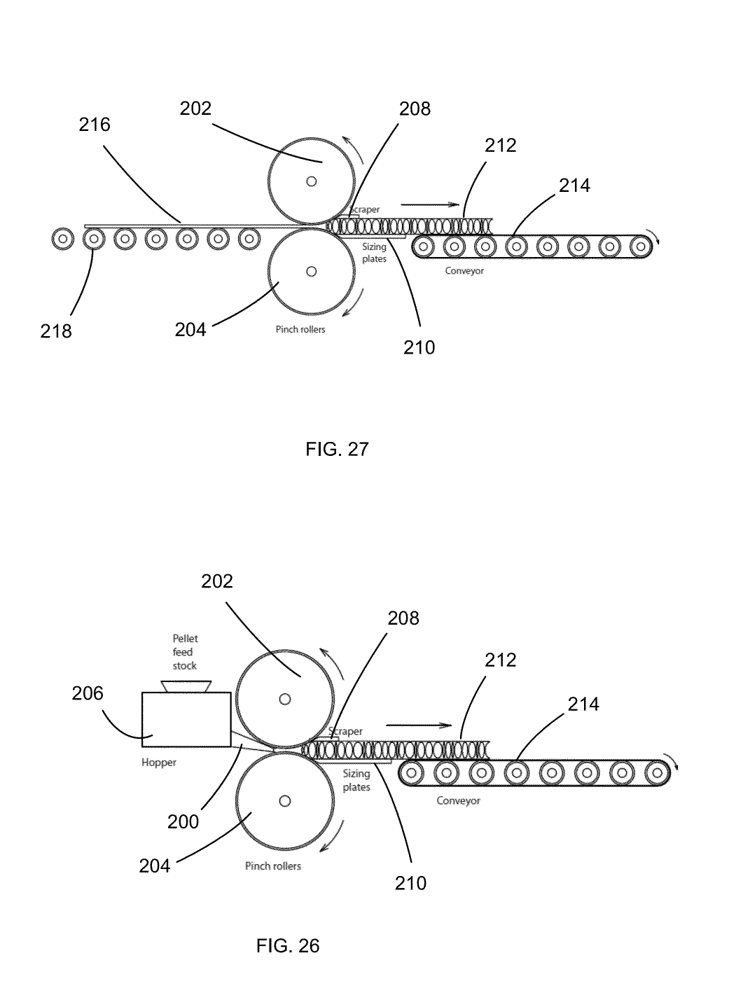

In an exemplary embodiment, a cellular board material may be continuously produced by feeding a sheet of the melt-stretchable material to a pair of nip rollers, such as illustrated in FIGS. 26 and 27.

As depicted in FIG. 26, a melt-stretchable material is melted to form a sheet 200 of viscous molten mass formed of opposite surface layers connected by a central portion. The molten sheet 200 is continuously fed to a pair of nip rollers 202 and 204 (also called pinch rollers), and is heated to melt the material either shortly before it reaches nip rollers 202, 204 or at nip rollers 202, 204, so that the sheet of molten mass is fed through nip rollers 202, 204 continuously. Pellets of the melt-stretchable material may be stocked in a feeder 206 for feeding the pellets to nip rollers 202, 204. Nip rollers 202, 204 may be selected and configured so that they compress sheet 200 between them when sheet 200 is fed through nip rollers 202, 204 and adhere to a portion of sheet 200 when the portion is compressed between nip rollers 202, 204. As a result, nip rollers 202, 204 will pull the opposite surface layers of the portion away from one another as the portion leaves nip rollers 202, 204. After the surface layers are pulled away to the desired distance, the portion can be solidified and separated from nip rollers 202, 204. The portion leaving the nip rollers may be solidified by cooling and may automatically peel off of the nip roller surfaces when it is cooled. A peeling tool, such as a scraper 208 or a sizing plate 210, may also be provided to peel the solidified portion off the nip roll.

In the illustrated process, the central portion is stretched by pulling the surface layers away from one another to generate air cells randomly distributed throughout the central portion, without severing the central portion from the surface layers. This results in a cellular core formed from the stretched central portion covered with skins formed from the surface layers. The cellular core and the skins can be solidified such as by cooling to form a cellular board material 212. The surface layers may be substantially parallel and flat, and the skins may also be substantially parallel and flat.

Board material may be continuously carried away by a conveyer 214.

As illustrated in FIG. 27, in an alternative embodiment, a sheet 216 of melt-stretchable material may also be fed to nip rollers 202, 204 using conveyer rollers 218.

Nip rollers are sometimes also referred to as nip rolls or puller rolls. The general construction of conventional nip roll machines is known to those skilled in the art. A suitable nip roll assembly for use in embodiments of the present invention can be constructed by modifying a conventional nip roll assembly by those skilled in the art based on the disclosure herein.

As can be understood, the cellular board material can be continuously produced using a nip roll assembly; and a continuous forming process may be convenient and can increase production throughput.

In different embodiments, the melt-stretchable granules or sheet material may be replaced with a different stretchable material, such as a partially cured thermosetting material. For example, resins of a suitable thermosetting material may be partially polymerized and then stretched in a similar manner as described above with respect to melted granules, to form randomly arranged air cells in the material before the material is fully cured (polymerized) in the stretched state to retain the random cellular structure in the fully cured material.

In some embodiments, one or both stretching surfaces may be non-flat and may be shaped to form a product with a desired non-flat surface profile.

Embodiments of the present invention may have applications in a wide range of fields and industries, as can be understood by those skilled in the art. For example, the cellular materials described herein or formed according exemplary methods described herein may be used in aerospace, automotive, packaging, construction, and other industries. As the cellular materials can be conveniently re-formed, they may be particularly useful in energy or impact absorption applications.

Conveniently, a cellular material can be produced according to an embodiment of the present invention with minimal equipment in a simple, one-step process.

Exemplary embodiments of the present invention are further illustrated with the following examples, which are not intended to be limiting.

### EXAMPLES

### Example I

Sample cellular thermoplastic materials were produced without using any blowing agents, additives or adhesives.

Sample cellular board or sheet materials were formed from plastic pellets in a furnace with an operating temperature of 180° C. The forming apparatus included a press which had two aluminum platens mounded on a frame with adjustable height settings to position the platens. The internal temperature of the furnace and the temperature of the platens were measured by thermocouple and an infrared laser thermometer was used to monitor the temperature of the polymer in the furnace and in the press. The platens were preheated in the furnace until they reached a temperature between 60 and 100° C.

High melt strength PP pellets (0.31 N melt strength as measured by ISO 16790) were then placed on the lower platen and left in the furnace for approximately 10 to 12 minutes, until they formed a viscous melt. The pellets were approximately 2-4 mm in size and had an oblate spheroid shape. They were heated until a unitary molten mass was created. It was found that when the molten mass fully covered stretching surface portion of the platen, the resulting board had skins with little or no gaps or cracks. When the platens were pulled away before the stretching surfaces were fully covered (i.e., there were gaps on the surface between the melted granules), the resulting skins also had gaps.

At this point, the platens along with the PP pellets were removed from the furnace and placed in the press. The platens were compressed for approximately 30 seconds to ensure hot tack adhesion between the upper platen and the molten PP pellets. The upper platen was then raised vertically in the press, expanding the polymer pellets uniaxially and spontaneously creating a web structure. The platens were locked in place at the desired heights and the press was left to cool. After cooling for 6-7 minutes, the press reached a temperature of approximately 35° C., and the PP board, which had a stochastic honeycomb core structure, separated itself from the aluminum platens.

Sample board materials with different thickness (height) of from 10 to 35 mm were formed using PP pellets of a similar size. The relative density (ρ) of the sample board varied from 5% to 13% depending on the final thickness.

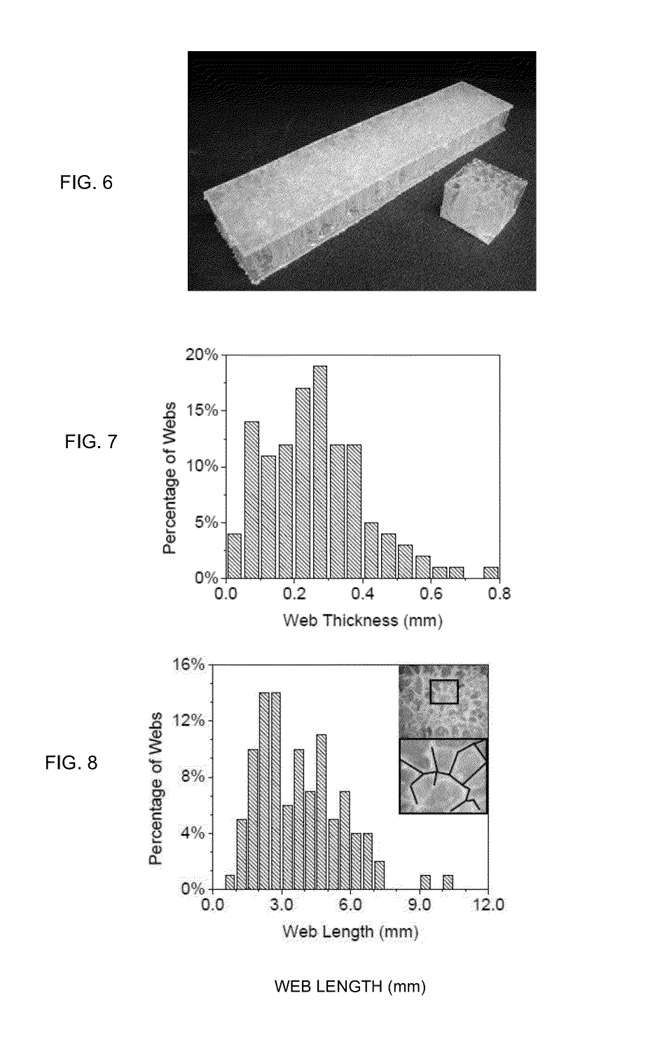

Representative images of the sample cellular materials are shown in FIGS. 5 and 6. As can be seen, each sample board had a cellular core covered by top and bottom skins. The cellular core had a stochastic honeycomb structure. In some samples, the skins and the central webs were of a thickness of about less than 1 mm. In the sample shown in FIG. 5, most of the webs were interconnected. In some samples, at least some of the webs were not interconnected to adjacent webs.

It was observed that a cellular architecture spontaneously formed in the samples as the opposing platens were separated, and there was substantial variation in the web structure in web thickness, web length and the angles between adjacent webs. As used herein, web thickness refers to the thickness of individual flat webs in the web structure, and its values were measured at the mid-point between the skins (mid-height); web height refers to the distance of the web between the skins; and web length refers to the length of each individual flat web surface between the web joints as seen from the top (e.g. as in the view of FIG. 5). The board thickness refers to the thickness of the entire sample board, which equals the web height plus the thickness of the skins.

FIG. 7 shows the distribution of web thickness (t) in samples having a board thickness of 20 mm and relative densities in the range of 7-7.5%. Measured web thickness varied between 0.025 mm and 0.800 mm. Typically, the individual webs were thicker near the skins and the joints between different webs and were thinner near the mid portions away from the skins and the joints, likely due to surface tension effects.

FIG. 8 shows the distribution of web length (l) in the samples of FIG. 7. The web length also varied, from 0.75 mm to over 10 mm, with the majority of webs having lengths between 1 and 7 mm.

The web thickness to web length aspect ratio (t/l) was in the range of 0.02 to 0.2, while the web thickness to web height aspect ratio (t/h) was in the range of 0.002 to 0.03.

Without being limited to any particular theory, it was expected that the following properties of PP facilitated or allowed the formation of the observed cellular web structure. The PP used was of high melt strength and had hot tack adhesion, a low melt flow rate, and a low surface energy. The hot tack adhesion property allowed PP to form an immediate bond with aluminum surfaces when the platen is hot. The molten PP adhered strongly to the aluminum stretching surfaces, allowing the PP pellets to be expanded uniaxially in the press. The PP used had a low melt flow rate (MFR) of 2.4 g/10 min, which limited the flow of PP in the melt state. The low MFR was related to the high melt strength of the PP, which had a value of 0.31 N as measured according to ISO 16790. In comparison, the melt strength for conventional PP is between 0.01 N and 0.20 N. While such lower melt strength PP may also be used, the pore structure in the resulting product may be less uniform, as compared to the pore structure formed from a higher melt strength PP. The low surface energy of the PP used meant that the PP material was a poor adhesive in the solid state. Thus, conveniently, the cooled sample boards could spontaneously separate from the aluminum platens.

### Example II

### Testing Sample Preparation

Sample boards with a board thickness of 20 mm and relative densities ranging from 7 to 12% as formed in Example I were used in tests described below.

30 mm×30 mm coupons were cut from the as-fabricated samples and used for compression testing at a cross-head speed of 1 mm/min, in accordance with ASTM C365 Standard Test Method for Flatwise Compressive Properties of Sandwich Cores (ASTM International. 2005).

Web collapse mechanisms during compression testing were investigated by pre-loading samples to characteristic uniaxial strain values and studying the deformed web structure in a scanning electron microscope (SEM).

Three-point bend samples were also made in the same manner, and cut into testing species of 200 mm long and 45 mm wide, in accordance with ASTM C393 Standard Test Method for Core Shear Properties of Sandwich Constructions by Beam Flexure (ASTM International. 2006); and ASTM D7250 Standard Practice for Determining Sandwich Beam Flexural and Shear Stiffness (ASTM International. 2006).

### Example III

### Attachment of Face Sheets to Samples

PP face sheets of different thickness (t_{f}=0.73 mm, 0.94 mm, 1.19 mm and 1.75 mm) were joined to a subset of the three-point bend samples prepared in Example II using thermal welding. The reinforcing face sheets were heated on the upper and lower aluminum platens in the furnace until they formed a melt. The lower platen was then fixed in the press as in Example I, with the three-point bend sample placed on top, and the upper platen fixed in the press at a height of 20 mm. It was found that the PP face sheets were adhered to the cellular sample without materially affecting the web structure in the cellular sample.

### Example IV

### Cellular Architecture in Samples

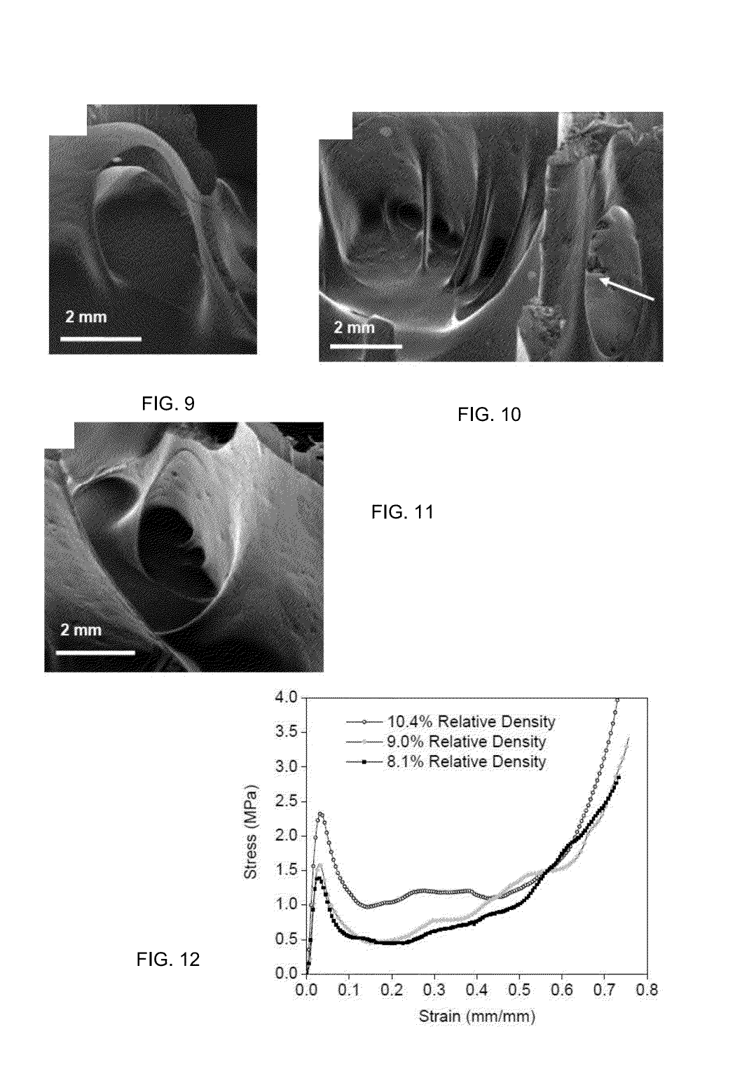

In the sample boards, a complex network of partial webs connected the slender webs of the stochastic honeycomb core to the surface skins. Representative SEM images of portions of the cellular and web structures in different samples are shown in FIGS. 9, 10 and 11. The SEM images were taken from honeycomb cores cut at mid-height.

It was observed that while much of the mass of the web structure was contained in either the skins or the complete webs (i.e. those webs extending continuously between the skins), there were also numerous incomplete webs. Some of the webs had gaps which extended to one of the skins (see FIG. 9). Some of the webs had gaps fully contained within the web (one such gap is indicated by an arrow in FIG. 10).

### Example V

### Re-Forming of Samples

Because the sample boards were formed of only PP, it would be easy to recycle. The boards could be pelletized without the need for separating the face sheets from the cellular core. The boarders could also be shaped without re-pelletization. Test studies were carried out, wherein a stochastic honeycomb core was fabricated as in Example I and subsequently crushed by uniaxial compression in a direction normal to the skin surface, and the crushed sample board was re-stretched (expanded). It was found that the re-stretched board did not exhibit significant loss in mechanical properties, as compared to the initial sample board.

The sample materials could be recycled without any special preparation. The sample materials could also allow refabrication by melting down the samples and re-stretching the core uniaxially in a press, without repelletization.

### Example VI

### Strain Stress Testing of Samples

Stain-stress tests were performed on the test samples as prepared in Example I. FIG. 12 shows representative uniaxial compression stress-strain curves for three different densities of the test samples. As can be seen, the curves had an initial peak stress, followed by a broad valley in which the stress was relatively constant until final densification.

To determine how the webs collapsed during compression, deformation in the same mid-height location of a sample with 11.5% relative density (ρ=11.5%) was tracked from the as-prepared state through to final densification.

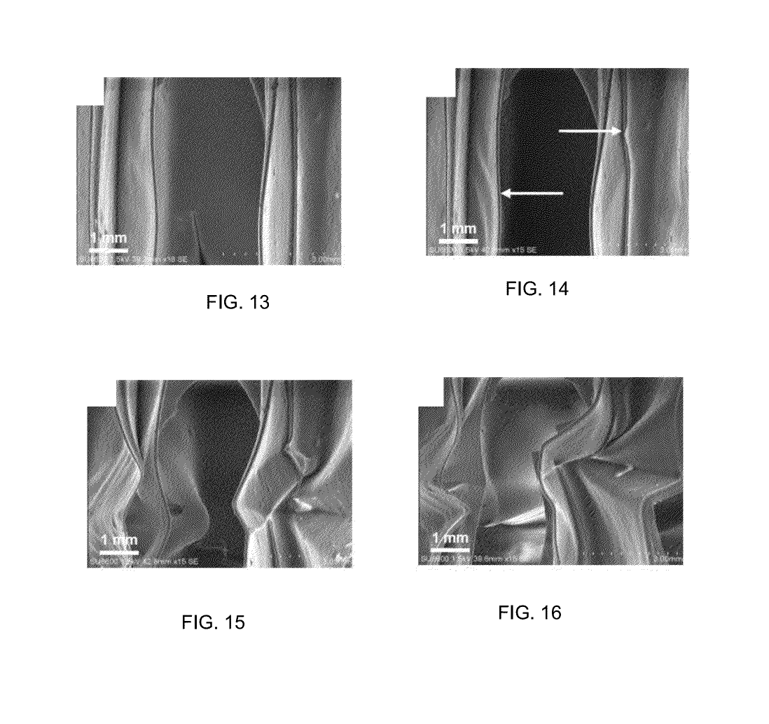

FIGS. 13, 14, 15 and 16 show SEM images of the cell structures in the original sample (FIG. 13) and after different pre-loading to strains of ε≈0.05 (FIG. 14), ε≈0.25 ((FIG. 15) and ε≈0.35 (FIG. 16). The slenderness of the web structure can be seen in FIG. 13. Local plastic buckling (indicated by arrows) can be seen in samples pre-loaded to the peak stress (FIG. 14). Large scale global buckling had occurred by the time the valley stress had been reached (FIG. 15) and continued through densification (FIG. 16).

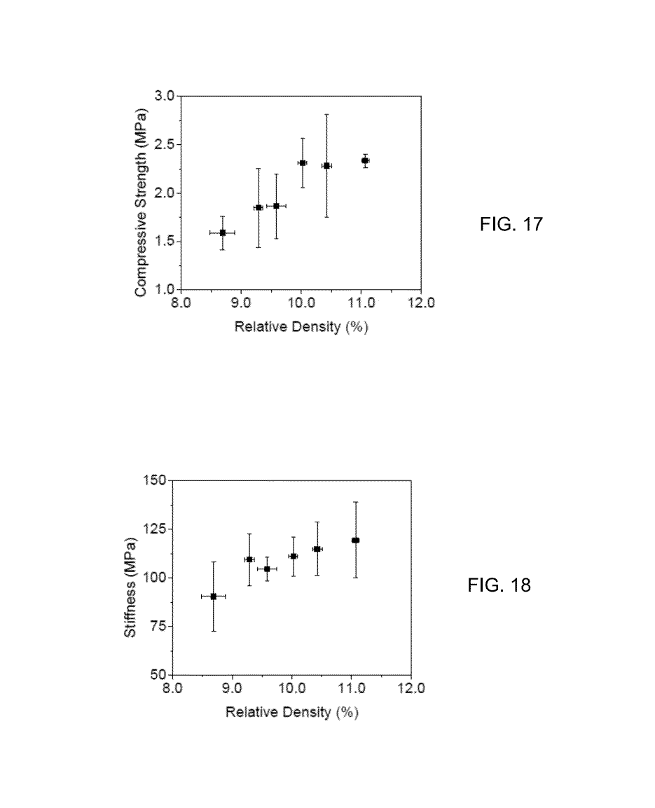

FIGS. 17 and 18 show the measured peak strength and stiffness plotted against the relative density of the test sample. While the strength increased from 1.5 MPa at 8.5% relative density to 2.5 MPa at 11.1% relative density, the specific strength values were approximately constant at 22.0±3.0 kPa-m³/kg. Similarly the stiffness varied from 90 MPa to 120 MPa over the same density range, and the specific stiffness was nearly constant at 1.17±0.06 MPa-m³/kg.

The specific strength of the samples (22.0 kPa-m³/kg) was approximately 3 to 5 times higher than that of conventional, commercial PP foams which were reported to be, e.g., 3-8 kPa-m³/kg. The specific stiffness of the samples (1.17 MPa-m³/kg) was approximately 4 to 10 times higher than the reported stiffness (e.g. 0.10-0.30 MPa-m³/kg) of commercial PP foams.

The tests also showed that sample cellular PP materials with a stochastic honeycomb core had compressive performance comparable to the performance of conventional PP honeycomb cores and exceeding the performance of conventional PP foams.

### Example VII

### Three-point Bend Testing

The three-point bend tests were conducted at a cross-head speed of 1 mm/min and span length of 100 mm. The samples as prepared in Examples I and II were first tested in the as-fabricated condition.

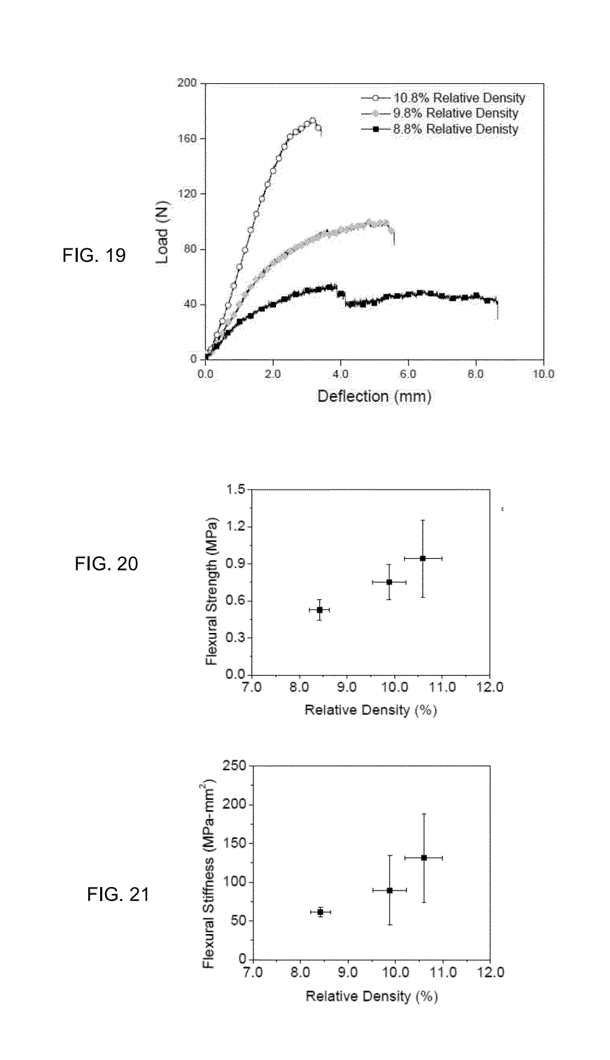

FIG. 19 shows representative load-deflection curves for samples having relative densities of 8.5%, 9.5%, and 10.5%. As the density increased, the samples failed at a lower deflection and a higher load.

FIGS. 20 and 21 show the flexural strength and flexural stiffness of the samples as a function of relative density, respectively. Both the flexural strength and flexural stiffness increased from 0.53 MPa to 1.08 MPa and from 61.4 MPa-mm² to 146.0 MPa-mm² respectively as the relative density increased from 8.4% to 11.0%. The significantly greater flexural strength and stiffness of the higher relative density stochastic honeycomb cores might be partly explained by differences in the skin thickness. For example, the average skin thickness on a ρ=10.5% sample was ˜0.24 mm while the average skin thickness on a ρ=8.5% sample was ˜0.14 mm.

Some test samples were reinforced with additional polypropylene face sheets having thicknesses varying from 0.73 mm to 1.75 mm. External face sheets were joined to the sample material without using an adhesive.

Sandwich panels under three-point bend testing typically fail by one of four mechanisms: delamination of the face sheet, wrinkling of the face sheet, core shear failure, and face sheet yield and fracture. All four of these failure mechanisms were observed in the reinforced test samples. However, it was found that through careful sample preparation delamination of the face sheets could essentially be eliminated.

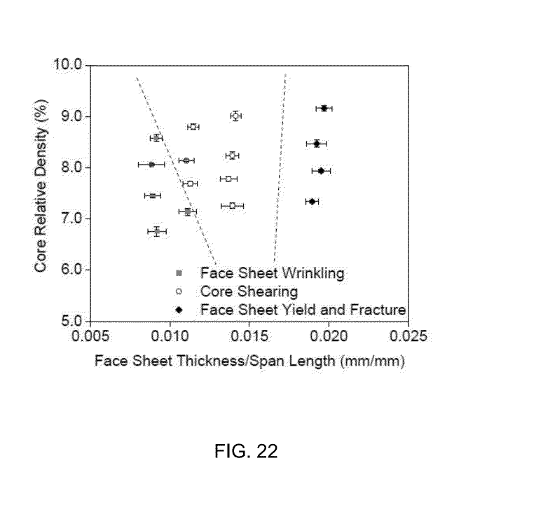

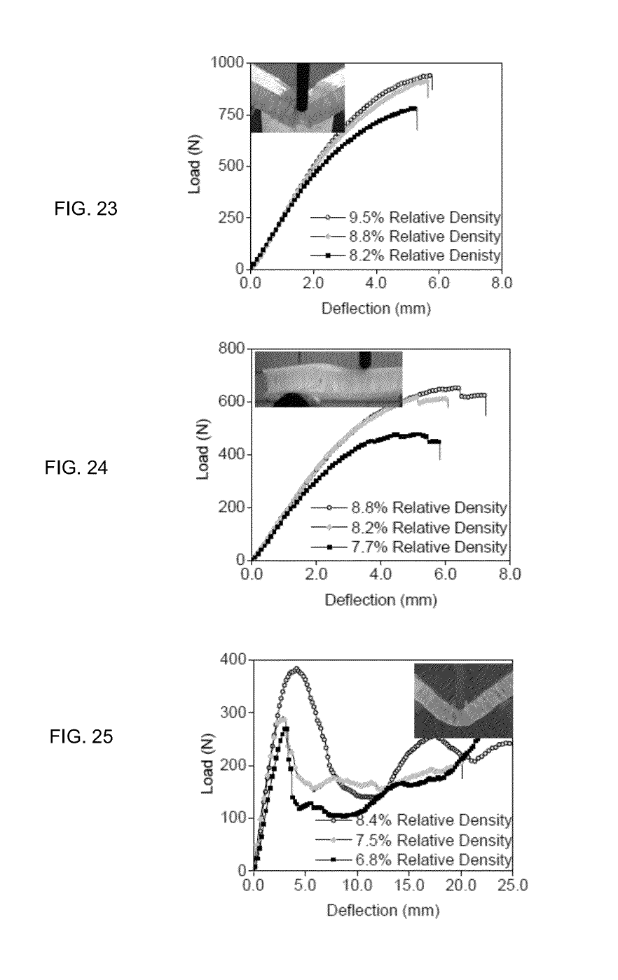

FIG. 22 summarizes the failure mechanisms in the form of a failure map for the test samples. It was found that at lower face sheet thicknesses and lower densities, wrinkling was the dominant failure mechanism. As the face sheet thickness increased, along with the density, core shearing and then face sheet yield and fracture consecutively became the dominant failure mechanisms. Representative load-displacement curves for each of these failure mechanisms are shown in FIGS. 23, 24 and 25.

The samples that failed primarily through face sheet yield and fracture failed at the highest applied loads (see FIG. 23). These samples generally deformed to between 4 and 6 mm deflection and then snapped, failing abruptly. For t_{f}=1.75 mm, the flexural strength and stiffness varied from 5.14 MPa and 546 MPa-mm² at 7.3% relative density to 6.85 MPa and 660 MPa-mm² at a relative density of 9.2%, respectively.

Core shearing occurred mostly in the samples with face sheet thicknesses of 0.94 mm and 1.19 mm. In both cases, cracking noises could be heard as the core progressively sheared, corresponding to periodic load drops in the load-displacement curves. For both face sheet thicknesses, the flexural strength and stiffness increased with core density. When t_{f}=0.94 mm, the flexural strength and stiffness increased from 4.32 MPa and 370 MPa-mm² at 7.1% relative density to 5.24 MPa and 418 MPa-mm² at 8.8% relative density, respectively. Similarly, when t_{f}=1.19 mm, the flexural strength and stiffness increased from 4.48 MPa and 455 MPa-mm² at 7.2% relative density to 4.65 MPa and 629 MPa-mm² at 9.1% relative density, respectively.

Wrinkling of the face sheet caused the samples to fold in on themselves, and most did not fracture but rather slid off of the supports after reaching displacements of more than 65 mm. Samples that failed by face sheet wrinkling had the thinnest PP sheet reinforcement and failed at the lowest peak loads. When t_{f}=0.73 mm, the flexural strength and stiffness increased from 1.88 MPa and 301 MPa-mm² at 6.8% relative density to 2.73 MPa and 333 MPa-mm² at 8.6% relative density, respectively.

In the reinforced test samples, failure was either largely controlled by the face sheet (in face sheet yield and fracture) or by the core (in core shearing and wrinkling). When sample failure was controlled by the face sheet (for t_{f}=1.75 mm), the specific flexural strength and stiffness varied by less than 2% over all the samples, at 82.0±2.0 kPa-m³/kg and 8.22±0.16×10⁻⁶ Pa-m⁵/kg respectively. Alternatively, when sample failure occurred primarily in by the core, much larger variation in the specific flexural strength and stiffness was seen. For t_{f}=1.19 mm (failure by core shearing), the specific flexural strength was 63.0±6.0 kPa-m³/kg, a variation of 9%, and the specific flexural stiffness was 6.84±0.82×10⁻⁶ Pa-m⁵/kg, a variation of 12%. For t_{f}=0.73 mm (failure by wrinkling), the specific flexural strength and stiffness were 32.0±3.0 kPa-m³/kg and 4.38±0.57×10⁻⁶ Pa-m³/kg, variations of 10% and 13% respectively.

At constant core density, the peak load increased with increasing face sheet thickness. Likewise, at constant face sheet thickness, the peak load increased with increasing core density. It should be noted that relatively larger sample-to-sample variability was seen in the flexural properties of the as-prepared samples than the reinforced samples. For example, at a core relative density of 8.5%, the flexural strength values for the as-prepared samples were within 15%, while at the same density, the reinforced samples varied by 8% on average. In flexure, fracture occurs at the outer surface and is more sensitive to changes in the local built-in or reinforced face sheet thicknesses. The reinforced sheets were not only much thicker, but also more uniform than the built-in skins, accounting for the reduction in variability in the reinforced samples.

In summary, when the samples without reinforcement were tested in three-point bending, the samples failed by face sheet yield and fracture, and the flexural strength and stiffness varied with the core relative density. When the samples were reinforced with external PP sheets, all four of the typically observed sandwich panel failure mechanisms were observed. With careful sample preparation it was possible to eliminate delamination in the reinforced samples. For all of the reinforced samples, the flexural strength and stiffness increased with core relative density at a constant face sheet thickness, and also increased with increasing face sheet thickness at constant core relative density.

When a list of items is given herein with an “or” before the last item, any of the listed items or any suitable combination of the listed items may be selected and used. For any list of possible elements or features provided in this specification, any sublist falling within a given list is also intended. Similarly, for any range provided, any subrange falling within a given range is also intended.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of forming a cellular material, comprising:
melting granules compressed between a first surface and a second surface, to form
a first viscous molten layer attaching first ends of said granules to said first surface and
a second viscous molten layer attaching second ends of said granules to said second surface;
stretching melted central portions of said granules between said first and second ends by moving said first and second surfaces away from one another, to form a cellular structure between said molten layers; and
solidifying said molten layers and cellular structure to form a solid material comprising a cellular core formed from said cellular structure and skins formed from said molten layers.

2. The method of claim 1, wherein said first and second surfaces are substantially parallel.

3. The method of claim 2, wherein said first and second surfaces are substantially flat.

4. The method of claim 1, wherein said melting comprises heating said granules.

5. The method of claim 4, wherein said heating comprises heating said granules to a temperature above the melting temperature of said granules.

6. The method of claim 1, wherein said solidifying comprises cooling.

7. The method of claim 1, wherein said granules are formed of a thermoplastic polymer.

8. The method of claim 7, wherein said thermoplastic polymer comprises polypropylene or polyethylene.

9. The method of claim 1, further comprising separating said surfaces from said solid material.

10. A material comprising a cellular structure formed from melt-stretched granules.

11. The material of claim 10, comprising skins covering said cellular structure.

12. The material of claim 11, wherein said cellular structure comprises webs connecting said skins.

13. The material of claim 11, wherein said skins have a porosity of less than 2%.

14. The material of claim 10, wherein said cellular structure has a porosity of about 10% or higher.

15. The material of claim 10, wherein said granules are formed of a thermoplastic polymer.

16. The material of claim 15, wherein said polymer comprises polypropylene or polyethylene.

17. The material of claim 10, wherein said cellular structure comprises randomly arranged honeycomb cells.

18. A method of forming a cellular material, comprising:
melting a melt-stretchable material to form a sheet of viscous molten mass formed of opposite surface layers connected by a central portion;
stretching said central portion by pulling said surface layers away from one another to generate air cells randomly distributed throughout said central portion, without severing said central portion from said surface layers, thus forming a cellular core from the stretched central portion and skins from said surface layers; and
solidifying said cellular core and said skins to form a cellular board material.

19. The method of claim 18, wherein said surface layers are substantially parallel.

20. The method of claim 18, wherein said surface layers and said skins are substantially flat.

21. The method of claim 18, wherein a first one of said surface layers adheres to a first pulling member and a second one of said surface layers adheres to a second pulling member, and said surface layers are pulled away from one another by moving said first and second pulling members away from one another.

22. The method claim 18, further comprising continuously feeding said sheet of molten mass through a pair of nip rollers, and wherein said nip rollers:
compress a portion of said sheet between said nip rollers when said portion of said sheet is fed through said nip rollers;
adhere to said portion when said portion is compressed between said nip rollers; and
pull said surface layers of said portion away from one another as said portion leaves said nip rollers, before said portion is solidified and separated from said nip rollers.
